(19) United States
(12) Patent Application Publication
(10) Pub. No.: US 2024/0428134 A1
(43) Pub. Date: Dec. 26, 2024

(54) AUTOMATED DRIFT RESOLUTION THROUGH A CONTEXT-BASED SELF-LEARNING TOOL FOR MACHINE LEARNING SYSTEMS

(71) Applicant: Technology Innovation Institute - Sole Proprietorship LLC, Masdar City (AE)

(72) Inventors: Thoorpu Karnakar Reddy, Abu Dhabi (AE); Hakim Hacid, Dubai (AE); Ebtesam Almazrouei, Abu Dhabi (AE)

(73) Assignee: Technology Innovation Institute - Sole Proprietorship LLC, Masdar City (AE)

(21) Appl. No.: 18/741,405

(22) Filed: Jun. 12, 2024

Related U.S. Application Data
(60) Provisional application No. 63/509,943, filed on Jun. 23, 2023.

(51) Int. Cl. G06N 20/00

(52) U.S. Cl. CPC G06N 20/00

(57) ABSTRACT

The present embodiments relate to systems and methods to intelligently handle different types of concept drift scenarios in a machine learning operations framework with minimal/no down time or loss in processing data. Particularly, the present embodiments enable a system to generate AI model specific instructions from raw data automatically and use the generated instructions to generate code blocks through which the machine learning system can intelligently come up with challenges of AI Model quality drop scenarios. The present embodiments can solve the problem of automatic concept drift resolution in machine learning operations systems. For instance, the present embodiments can recommend the best possible code blocks for data pipelines and ML pipelines based on data distributions. Further, the embodiments can improve and maintain the AI model quality in a production environment, and also improve the code quality based on validation from an operator.

### CROSS-REFERENCE TO RELATED APPLICATION

This application claims priority to U.S. Provisional Application Ser. No. 63/509,943, filed Jun. 23, 2023, which is incorporated by reference in its entirety.

### TECHNICAL FIELD

This disclosure relates to systems, methods, and computer-readable media for automated concept drift resolution in a machine learning model.

### BACKGROUND

Computing networks implementing machine learning (ML) systems are popular in a variety of contexts. Generally, machine learning can comprise a subfield of artificial intelligence, which is broadly defined as the capability of a machine to imitate intelligent human behavior. Artificial intelligence systems can be used to perform complex tasks in a way that is similar to how humans solve problems.

Generally, machine learning obtains input data (e.g., numbers, photos, text), where the input data can be gathered and prepared to be used as training data (e.g., the information the machine learning model will be trained on). The machine learning model can be trained using the training data and can then be fed live data to produce outputs, such as to output predictions or identified patterns. The model can further train itself to improve the accuracy of the model over time. Some data can be held out from the training data to be used as evaluation data, which can test how accurate the machine learning model is when it is shown new data. The result can include a model that can be used in the future with different sets of data.

Further, outputs from a ML model can be processed to determine whether a drift, such as a concept drift, is present. Concept drift in machine learning and data mining refers to the change in the relationships between input and output data in the underlying problem over time. A concept in concept drift can relate to the unknown and hidden relationship between inputs and output variables. For example, a concept in weather data may be the season that is not explicitly specified in temperature data but may influence temperature data. As the ML model continues to acquire and process new data, the feedback and learning of the model can result in concept drift.

### SUMMARY

The present embodiments relate to systems and methods to intelligently handle different types of concept drift scenarios in a machine learning operations framework with minimal/no down time or loss in processing data. Particularly, the present embodiments enable a system to generate AI model specific instructions from raw data automatically and use the generated instructions to generate code blocks through which the machine learning system can intelligently come up with challenges of AI Model quality drop scenarios. The present embodiments can solve the problem of automatic concept drift resolution in machine learning operations systems. For instance, the present embodiments can recommend the best possible code blocks for data pipelines and ML pipelines based on data distributions. Further, the embodiments can improve and maintain the AI model quality in a production environment, and also improve the code quality based on validation from an operator.

A first example embodiment can provide a method for retraining a machine learning model in response to detecting a concept drift of the machine learning model. The method can include obtaining a detection of an occurrence of a concept drift in a machine learning model. The method can also include generating a dataset specific to the machine learning model from a set of input data.

The method can also include generating a set of instructions from the dataset. The method can also include generating, for each of the set of instructions, a code set and a test code set for testing the code set according to each instruction of the set of instructions. The method can also include merging the code set and the test code set into a merged code set.

The method can also include validating the merged code set. The method can also include re-training the machine learning model using the merged code set. The method can also include deploying the re-trained machine learning model.

In another example embodiment, a system is provided. The system can include a processor and a computer readable medium. The computer readable medium can contain instructions that, when executed by the processor, cause the processor to perform operations.

The operations can include obtaining a detection of an occurrence of a concept drift in a machine learning model. The operations can also include generating a dataset specific to the machine learning model from a set of input data. The operations can also include generating a set of instructions from the dataset.

The operations can also include generating, for each of the set of instructions, a code set and a test code set for testing the code set according to each instruction of the set of instructions. The operations can also include re-training the machine learning model using the code set and the test code set. The operations can also include deploying the re-trained machine learning model.

In another example embodiment, a computer-readable storage medium is provided. The computer-readable storage medium can contain program instructions for a method being executed by an application, the application comprising code for one or more components that are called by the application during runtime. Execution of the program instructions by one or more processors of a computer system can cause the one or more processors to perform steps comprising obtaining a detection of an occurrence of a concept drift in a machine learning model.

The steps can also include generating, by a data to instructions generator, a dataset specific to the machine learning model from a set of input data.

The steps can also include generating, by an instructions controller, a set of instructions from the dataset. A number of instructions in the set of instructions can be controlled by the instructions controller. The steps can also include generating, for each of the set of instructions by an operations code generator, a code set according to each instruction of the set of instructions.

The steps can also include generating, for each of the set of instructions by a test operations code generator, a test code set for testing the code set. The steps can also include merging the code set and the test code set into a merged code set. The steps can also include validating the merged code set; The steps can also include re-training the machine learning model using the code set and the test code set. The steps can also include deploying the re-trained machine learning model.

In any of the example embodiments, a number of instructions in the set of instructions generated by the instructions controller can be controlled by an instructions controller.

In any of the example embodiments, the instructions controller can interact with a large language model (LLM) to generate the set of instructions.

In any of the example embodiments, validating the merged code set further comprises obtaining, for the merged code set, a set of feedback and generating a reward based on the set of feedback. A subsequent code set and test code set can be generated based on the generated reward being negative.

In any of the example embodiments, the dataset comprises any of a set of integers, real values, categorical data, and float values. The set of instructions can include instructions to generate functions to perform an action relating to any portion of the dataset.

In any of the example embodiments, the dataset comprises sample text, the set of instructions comprise instructions to generate a function to perform an action relating to a portion of the sample text. The code set can include the function providing instructions to perform the action relating to the portion of the sample text.

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1 is an example illustration of a block diagram for implementing and updating a model according to an embodiment.

FIG. 2 includes a graphical representation of an exemplary model performance over time according to an embodiment.

FIG. 3 is a high-level representation of a flow process for machine learning system optimization according to an embodiment.

FIG. 4 is an example block diagram for automatic concept drift resolution in machine learning operations systems according to an embodiment.

FIG. 5 is an example flow process for automatic concept drift resolution in machine learning operations systems according to an embodiment.

FIG. 6 illustrates a first example flow process for generating a set of instructions according to an embodiment.

FIG. 7 illustrates a second example flow process for generating a set of instructions according to an embodiment.

FIG. 8 illustrates a third example flow process for generating a set of instructions according to an embodiment.

FIG. 9 is a flow process illustrating an operations code generator and an operations test code generator according to an embodiment.

FIG. 10 illustrates an example flow process for retraining a machine learning model in response to detecting a concept drift of the machine learning model.

FIG. 11 is a block diagram of a special-purpose computer system according to an embodiment.

### DETAILED DESCRIPTION

Computing networks implementing machine learning (ML) systems are popular in a variety of contexts. Generally, machine learning can comprise a subfield of artificial intelligence, which is broadly defined as the capability of a machine to imitate intelligent human behavior. Artificial intelligence systems can be used to perform complex tasks in a way that is similar to how humans solve problems.

Generally, machine learning obtains input data (e.g., numbers, photos, text), where the input data can be gathered and prepared to be used as training data (e.g., the information the machine learning model will be trained on). The machine learning model can be trained using the training data and can then be fed live data to produce outputs, such as to output predictions or identified patterns. The model can further train itself to improve the accuracy of the model over time. Some data can be held out from the training data to be used as evaluation data, which can test how accurate the machine learning model is when it is shown new data. The result can include a model that can be used in the future with different sets of data.

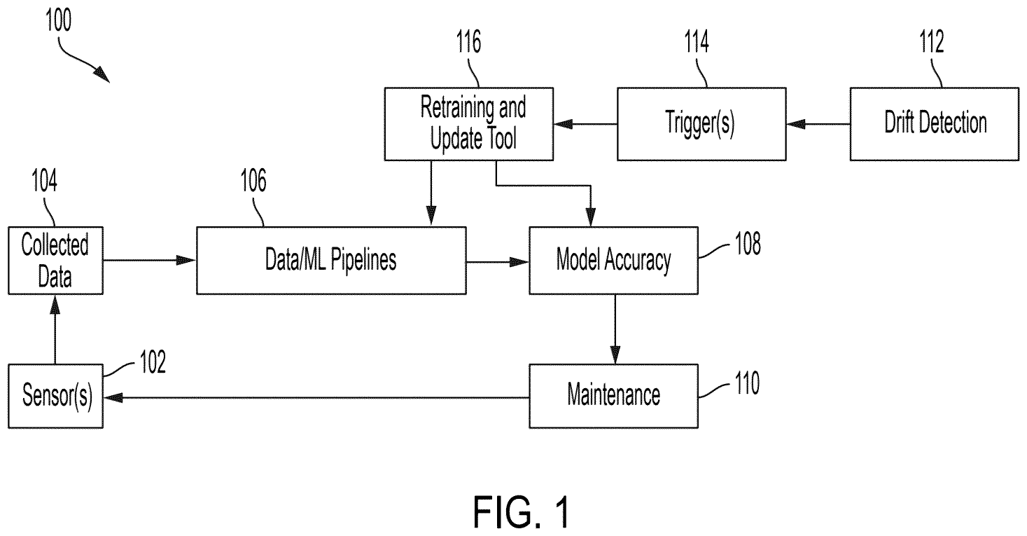

FIG. 1 is an example illustration of a block diagram 100 for implementing and updating a model according to an embodiment. As shown in FIG. 1, input data can be obtained by one or more sensors 102. The sensors 102 can include any device capable of obtaining raw data, such as image sensors, radar sensors, lidar sensors, etc. The collected data 104 can be collected from one or more sensors and fed into data/ML pipelines 106. The data/ML pipelines 106 can include machine learning models configured to obtain collected data 104 and derive outputs (e.g., predictions, identified features or patterns) based on the collected data 104. In some instances, multiple ML models can be used as part of a deep learning system to perform a task (e.g., such as to operate a vehicle autonomously).

Further, a ML model can be evaluated for accuracy (e.g., 108). For instance, a ML model 106 can be evaluated using evaluation data or feedback can be obtained relating to an output of the ML model 106 to generate an accuracy of the model. The model accuracy 108 can be derived based off any of a variety of metrics, as described in greater detail below. Various forms of maintenance 110 and/or feedback can be fed back into the model for use in subsequent processing of sensor data.

Further, outputs from a ML model 106 can be processed to determine whether a drift, such as a concept drift, is present. Concept drift in machine learning and data mining refers to the change in the relationships between input and output data in the underlying problem over time. A concept in concept drift can relate to the unknown and hidden relationship between inputs and output variables. For example, a concept in weather data may be the season that is not explicitly specified in temperature data but may influence temperature data. As the ML model continues to acquire and process new data, the feedback and learning of the model can result in concept drift.

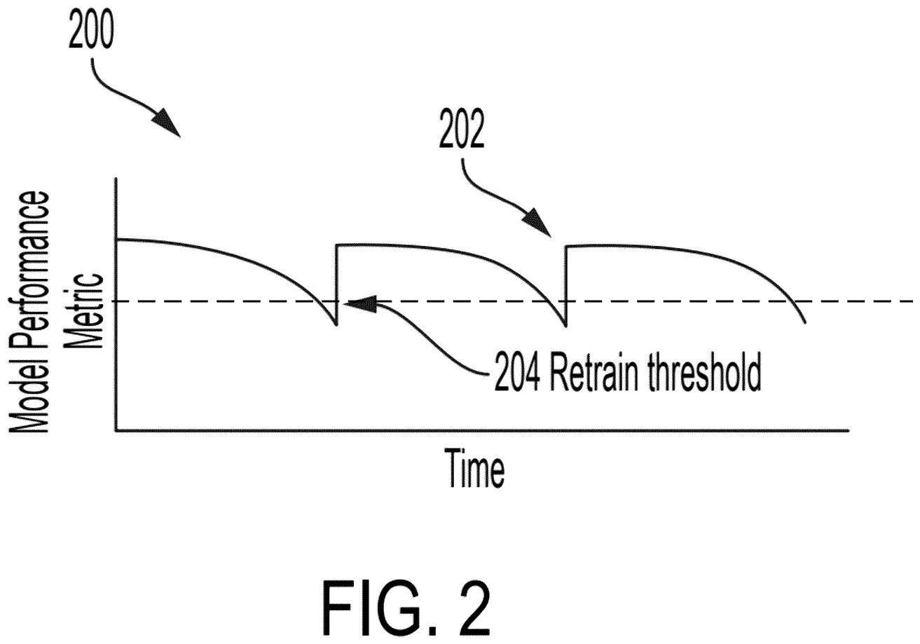

Referring back to FIG. 1, a drift detection model 112 can detect whether a drift is present for the model. This can include determining that a model accuracy is below a threshold level. Further detail relating to drift detection is described with respect to FIG. 2.

In response to detecting concept drift, one or more triggers 114 can be initiated. The triggers 114 can initiate specific retraining and/or updating of the ML model 106 using a retraining and update tool 116. In response to generating retraining and updating the model (e.g., via 116), the updates can be fed to the ML pipeline 106 and/or a model accuracy 108.

As noted above, concept drift can be caused due at least in part due to changes in data distribution of the ML model. FIG. 2 includes a graphical representation 200 of an exemplary model performance over time according to an embodiment. For instance, as shown in graph 200, a trendline 202 can illustrate that a model performance metric can gradually reduce over time, and a retraining of the model can occur at various time instances. The model performance metrics can depend on a model type. For example, if the model is a regressive model, a metric can include a mean squared error, root mean square error, etc. If a model is a classifier model, a metric can include a model accuracy, F1 score, etc. At such instances, the model can be retrained (e.g., when the metric falls below a retrain threshold 204).

In many instances, retraining a ML model can be resource and/or time intensive. In many cases, retraining a model can result in taking a model offline for an extended period of time for an operator to retrain the model. Extended downtime of a model can cause increased delays in the ML model processing data as described herein.

In many cases, in data intensive Machine Learning (ML) systems, frequent data drifts happen, causing a quality of the ML/AI systems to drop and result in potential down-time. The present embodiments relate to how to handle frequent concept drift scenarios in ML systems to keep up with changes in quality in the ML systems. The present embodiments can build systems and methods that automatically and intelligently generate ML code and necessary tests from a given data (distribution) for automated drift resolution.

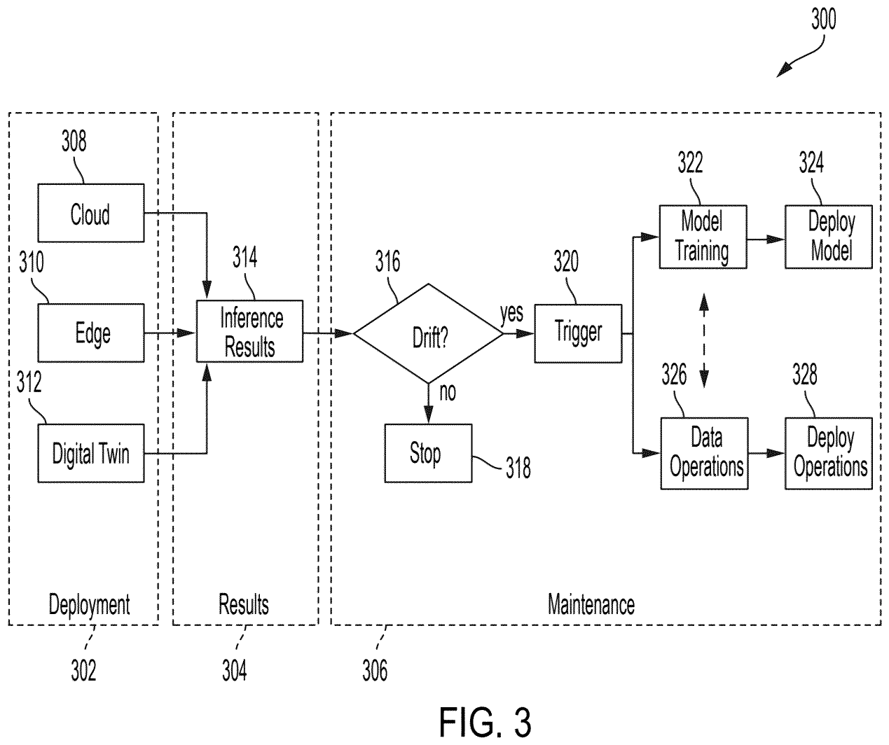

FIG. 3 is a high-level representation of a flow process 300 for machine learning system optimization. As shown in FIG. 3, optimizing a machine learning system can relate to any of deployment 302, results 304, and maintenance 306. For deployment 302, the machine learning model can be deployed in a cloud infrastructure 308, edge device(s) 310, and/or as a digital twin 312.

The inference results 314 can be obtained from the machine learning model as part of results 304. This can include providing inputs to a machine learning model and obtaining an output from the model as a result of the model.

Maintenance of the model (e.g., 306) can include retraining and/or updating the model and deploying the updated model. For instance, in FIG. 3, at 316, a drift can be detected. If no drift is detected (e.g., 318), the maintenance process can stop. At 320, a trigger can be initiated in response to identifying a drift.

Further, the model can be trained 322 and data operations 326 (e.g., transformations, normalizations, standardizations, cleansing) can be performed with respect to the model. This can include retraining the model and/or generating new training data to correct for any concept drift for the model. The updated model (e.g., 324) and data operations can be deployed (e.g., 328) corrected for the previously identified concept drift.

The present embodiments relate to systems and methods to intelligently handle different types of concept drift scenarios in a machine learning operations framework with minimal/no down time or loss in processing data. Particularly, the present embodiments can enable a system to generate AI model specific instructions from raw data automatically and use the generated instructions to generate code blocks that can increase model accuracy in concept drift scenarios.

An example process to intelligently handle different types of concept drift scenarios in a machine learning operations framework can include a series of steps. For example, the steps can include collecting a set data and creating a dataset. The steps can also include generating a set of instructions from the dataset. A number of instructions can be controlled using a problem specific instruction controller.

A set of code and test cases can be generated from the generated instructions. Further, the generated code and test cases can be merged into the original code. The merged code can be validated and the results can be checked based on model performance and code test cases. The model can be run using the merged code and tested.

The present embodiments can solve the problem of automatic concept drift resolution in machine learning operations systems. The present embodiments can recommend the best possible code blocks for data pipelines and ML pipelines based on data distributions. Further, the embodiments can improve and maintain the AI model quality in a production environment, and also improve the code quality based on validation from an operator.

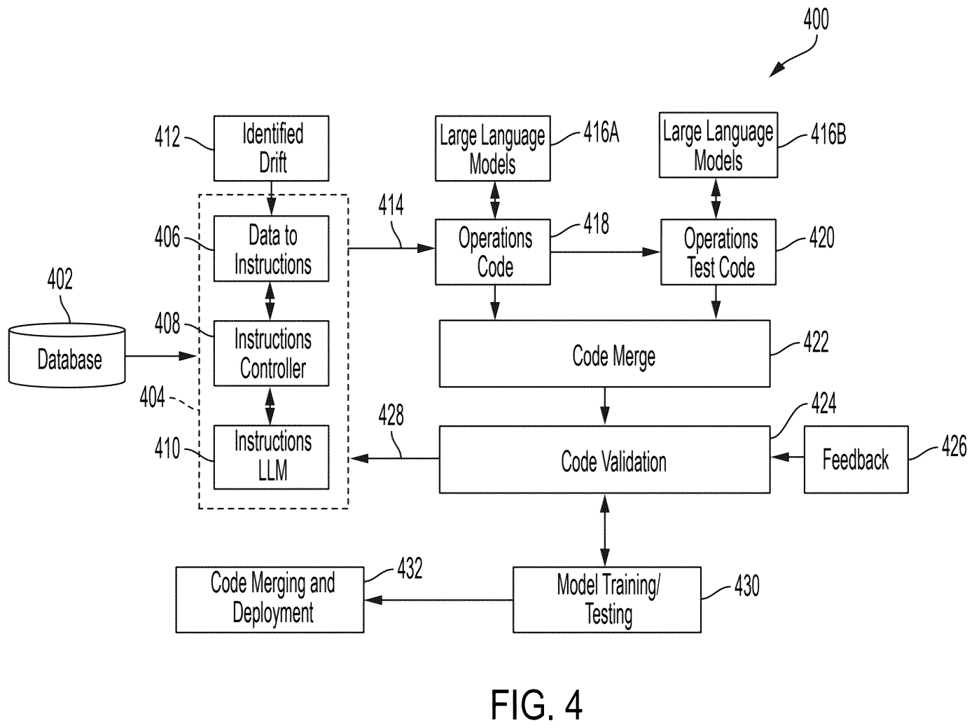

FIG. 4 is an example block diagram 400 for automatic concept drift resolution in machine learning operations systems. As shown in FIG. 4, a database 402 providing raw data can be fed into an instructions generation system 404. The instructions generation system 404 can include a data to instructions system 406, instructions controller 408, and/or an instructions large language model (LLM) 410. The instructions generation system 404 can obtain raw data from database 402 and generate a set of instructions in response to an identified drift (e.g., 412) as described herein.

The data to instructions system 406 can understand data distributions from the database 402, with an input of data (d(xᵢ)) and an output of instructions which are related to a specific problem and data relating to the machine learning model f(d(xᵢ))=Iᵢ.

The instructions controller 408 can understand the instructions generated by data to instructions system and control the number of instructions to be generated in view of the concept drift identified with the machine learning model. The controller 408 can have an input of instructions (Iᵢ) and an output of problem-related instructions.

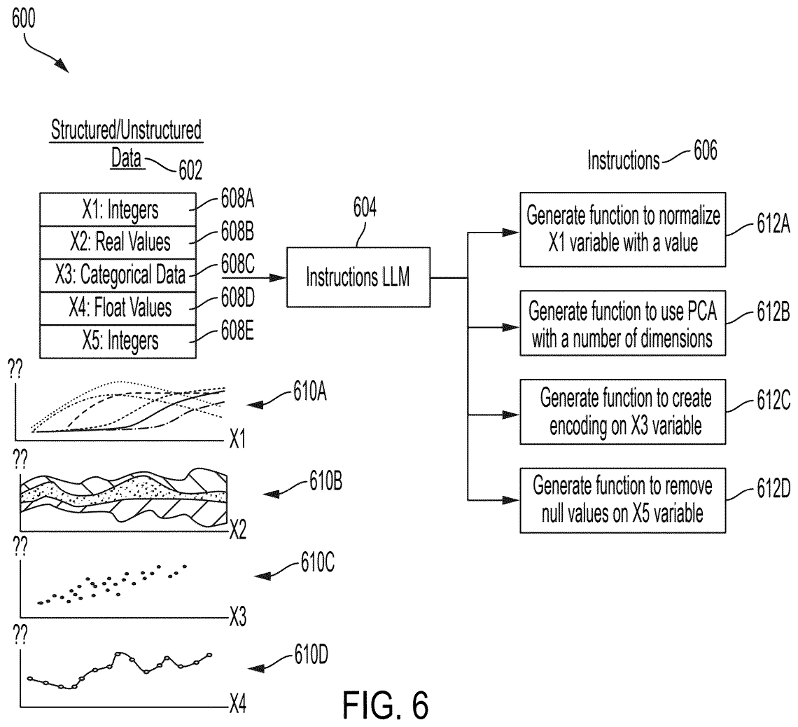

The set of instructions (e.g., 414) can be sent to operations code 418 and operations test code 420 generation subsystems. In response, the operations code 418 generation subsystem can generate a code set based on each instruction. The code sets can include defined functions or code objects configured to implement one or more functions as recited in each instruction. Example code sets are shown in greater detail with respect to FIGS. 6-8.

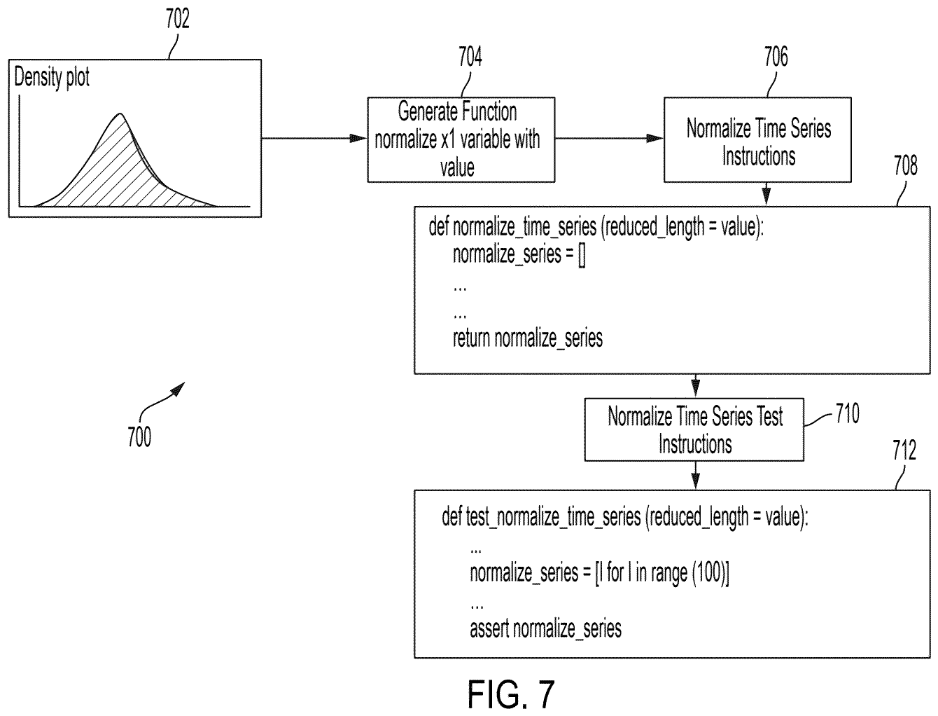

Further, operations test code 420 generation subsystem can generate test code for each code set generated by operations code 418 generation subsystem. Operations test code 420 generation subsystem can provide separate code sets configured to test the function(s) based on each instruction. An example test code set is provided at 708 in FIG. 7. The operations code 418 generation subsystem can be responsible for generating the code and the respective test cases, with an input of the received instructions and an output of the respective code.

Any of the operations code 418 and operations test code 420 generation subsystems can utilize large language models 416A-B to generate code sets and test code sets as described herein. For example, large language models 416A-B can provide text and code repositories to generate functions for the code set or test code set.

A code merge system 422 can merge the code set and test code. The merged code can include functions to both initialize the function and test the function by the model. Code validation 424 can validate the merged code and confirm results of the code. Validating the merged code can include obtaining feedback 426 from an operator or from a feedback model. Further, the code validation 424 system can generate rewards 428 to feed to the instructions generation subsystem 404. The rewards 428 can either be positive or negative and can dictate an accuracy of the generated instructions based on received feedback 426.

The code merge 422 can be responsible for merging the newly generated code into the code base. The input can include code blocks and the output can include the new code base. Further, code validation 424 can be responsible for generating rewards based on the operator validation of test results. The input for validation 424 can include the code base, and the output can include the rewards distribution.

The validated code can be fed into the model for model training/testing 430. Further, code merging and deployment 432 can include deploying the code set and/or the model for live data processing. The model training and testing 430 can be responsible for training the AI model and generating test results, with an input including the new dataset and the output being the trained model. The deployment 432 can be responsible for deploying the trained AI model and related code blocks into the platforms (e.g., edge, cloud), with an input including the code base and an output including the deployed code.

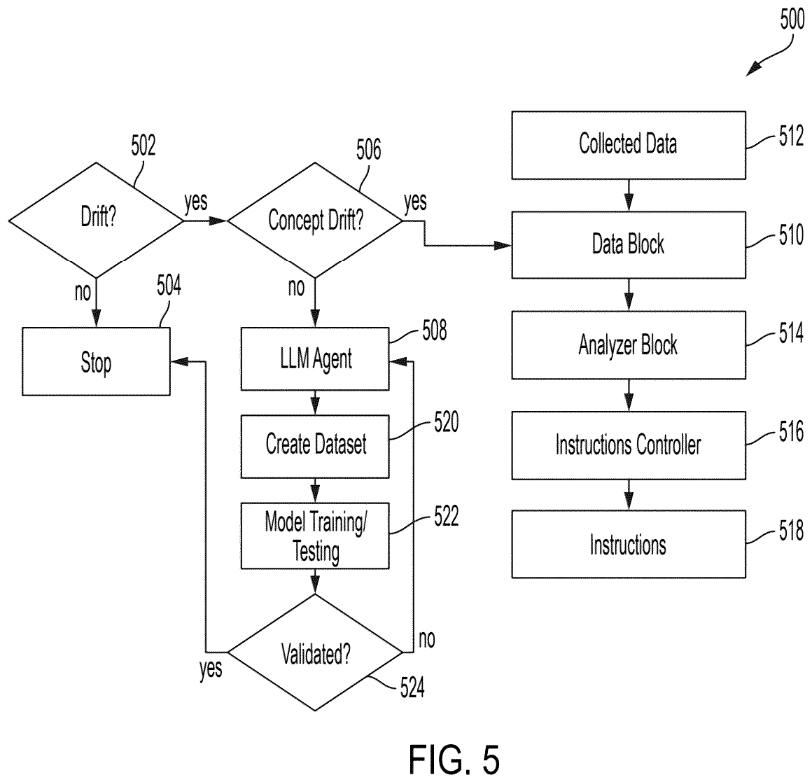

FIG. 5 is an example flow process 500 for automatic concept drift resolution in machine learning operations systems. At block 502, it can be determined whether a drift exists. A drift can include a data drift or concept drift in the machine learning model based on an analysis of various metrics of the model or feedback from an output of the model. At 504, if no drift is detected, the process can be stopped and periodically re-checked. At 506, if there is drift detected, it can be determined whether concept drift is detected. Concept drift can be determined based on an accuracy of the model or other metrics, as described herein.

If concept drift is detected, a new code set can be developed for the model for automatic drift resolution. For example, at 510, a data block can obtain collected data 512 and generate a dataset. The data block can produce any of structured data, time series data, and/or image/text data. The dataset can be fed into an analyzer block 514. The analyzer block 514 can include continuous and/or categorical data blocks with one or more LLM agents that can feed analyzed data into an instructions controller 516. The instructions controller 516 can generate the set of instructions 518 as described herein. The instructions 518 can be used to generate a code set for drift resolution of the model.

If no concept drift is detected, a LLM agent 508 can feed data into a create dataset block 520 for the purposes of dataset creation. The create dataset block 520 can create a dataset for the model. Further, a model training/testing block 522 can train and test the model using the created dataset for the model. If the trained model is validated at 524, the process can stop (e.g., 504). If the trained model is not validated, the process can repeat until the model is validated.

FIG. 6 illustrates a first example flow process 600 for generating a set of instructions. As shown in FIG. 6, the process 600 can include inputting a set of structured/unstructured data 602. The data 602 can include integers 608A, 608E, real values 608B, categorical data 608C, float values 608D, etc. Further, graphical data 610A-D illustrating plotted representations of input data X1-X5 that can be part of the input data 602. The instructions generation system (e.g., 404) can utilize an instructions LLM 604 and the input data 602 to generate a set of instructions 606.

The set of instructions 606 can include text-based or code-based instructions that provide instruction to generate training data for the model to reduce concept drift. For example, instructions can include an instruction to generate a function to normalize a X1 variable (e.g., 608A) with a value 30 (e.g., 612A), an instruction to generate a function to use principal component analysis (PCA) with 5 dimensions (e.g., 612B), an instruction to generate a function to create an encoding on the X3 variable (e.g., 608C) (e.g., 612C), and an instruction to generate a function to remove null values on a X5 variable (e.g., 608E) (e.g., 612D). The instructions (e.g., 612A-D) are used to generate code blocks that can be used to train the model to increase accuracy and cure concept drift in the model.

In another example, generated instructions can be used to generate code blocks for training the model. FIG. 7 illustrates a second example flow process 700 for generating a set of instructions. As shown in FIG. 7, a portion of the input data can include a density plot 702. Further, a generated instruction can include an instruction to generate a function to normalize the X1 variable with a value (e.g., 704). The operations code (e.g., 418) and test code systems (e.g., 420) can obtain the instruction 704 to generate normalized time series instruction code sets (e.g., 706) and test instructions 710.

For instance, in code set 706, code block 708 can include instructions (e.g., software code) defining a function to normalize time series data. In another example, code set 710 can include test instructions (e.g., software code) defining a function to test the function generated in code block 708. The code blocks 708, 712 can be generated according to the instruction 704 in a format specified by the instruction (e.g., Python).

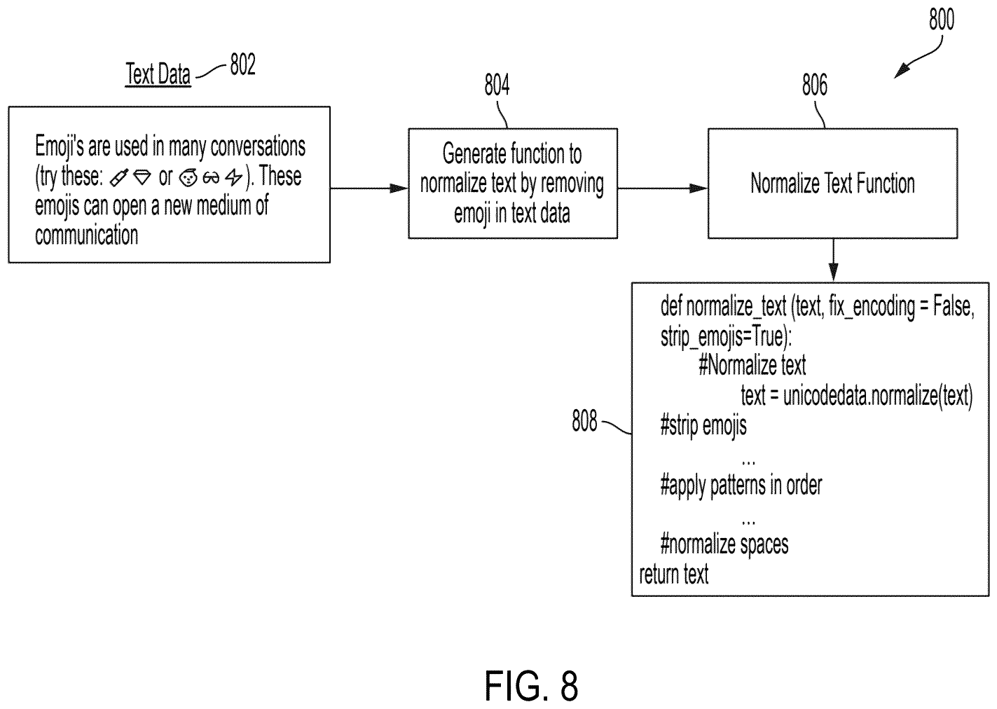

FIG. 8 illustrates a third example flow process 800 for generating a set of instructions. As shown in FIG. 8, an input can include text data 802 from a dataset. The text data can include text, numbers, emojis, etc. The instruction 804 can include an instruction to generate a function to normalize text by removing emojis in text data. The normalized text function 806 can be generated in response to the instruction by the operations code blocks (e.g., 418). The normalized text function 806 can include a code block (e.g., 808) that includes a function to normalize text by performing a series of actions (e.g., normalizing text, striping emojis, applying patterns, normalizing spaces).

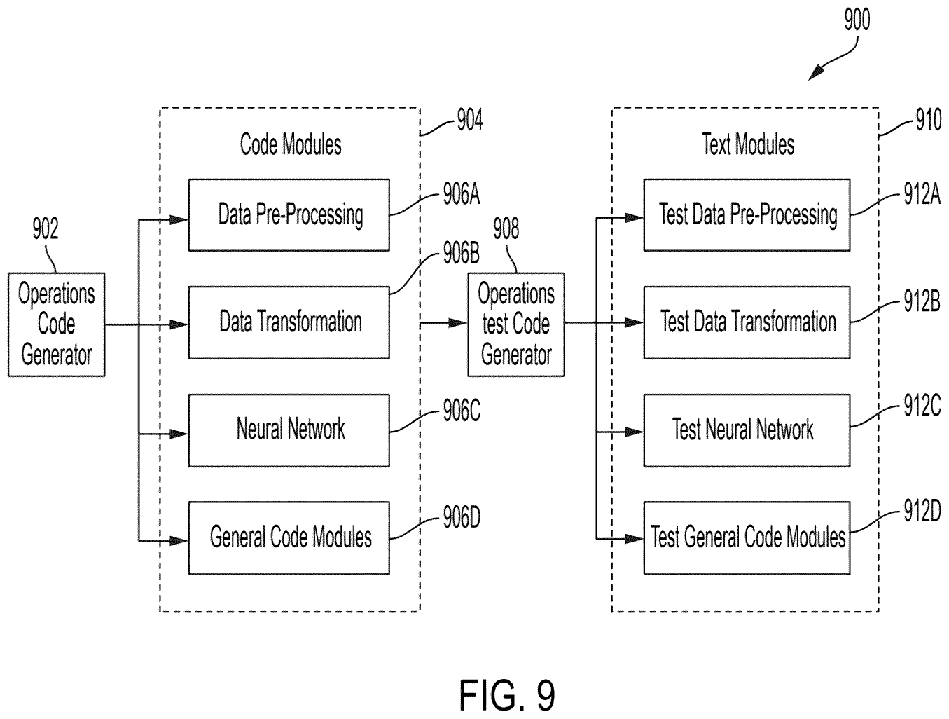

As recited herein, an operations code (e.g., 418) and operations test code (e.g., 420) systems can generate code in response to instructions generated by an instructions generation system 404. FIG. 9 is a flow process 900 illustrating an operations code generator and an operations test code generator.

As shown in FIG. 9, an operations code generator 902 can include code modules 904. The code modules 904 can include modules for generating operations code as described herein. The code modules can include a data pre-processing system 906A, a data transformation system 906B, a neural network 906C, and one or more general code modules 906D. The data pre-processing system 906A can interact with language models (e.g., large language models 416A) and/or derive insights into the instructions provided by the instructions generation system 404. Data pre-processing can include the process that can transform data into a specific format. For instance, data pre-processing can include removing unwanted data types, adding new data, normalizing data, performing a PCA process, etc.

The data transformation system 906B can transform the language data from the language models and insights derived from the instructions to generate an input that can be fed into the neural network 906C. The neural network 906C can process the input and generate operations code as described herein. The general code modules 906D can include modules relating to the machine learning model, such as pattern recognition modules, for example.

The operations test code generator 908 can generate test code as described herein. The test modules 910 can include modules for generating operations test code as described herein. The test code modules can include a test data pre-processing system 912A, a test data transformation system 912B, a test neural network 912C, and one or more test general code modules 912D. The test data pre-processing system 912A can interact with language models (e.g., large language models 416B) and/or derive insights into the instructions provided by the instructions generation system 404. The test data transformation system 912B can transform the language data from the language models and insights derived from the instructions to generate an input that can be fed into the test neural network 912C. The test neural network 912C can process the input and generate operations code as described herein. The test general code modules 912D can include modules capable of generating or analyzing test code.

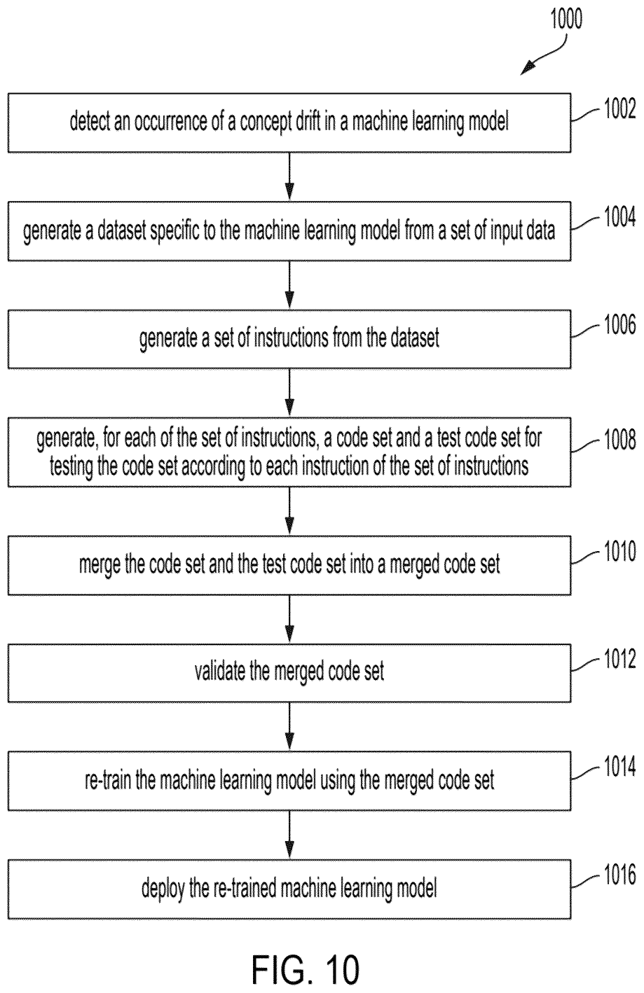

FIG. 10 illustrates an example flow process 1000 for retraining a machine learning model in response to detecting a concept drift of the machine learning model. At 1002, the process can include obtaining a detection of an occurrence of a concept drift in a machine learning model (e.g., at 412 in FIG. 4). Either a computing node performing the process as described herein can identify the concept drift or a computer remote to the computing node can identify the concept drift as described herein. In some instances, detecting the occurrence of concept drift includes periodically evaluating an output accuracy of the machine learning model and determining that the output accuracy of the machine learning model is below a threshold level.

At 1004, the process can include generating a dataset (e.g., data to instructions 406 in FIG. 4) specific to the machine learning model from a set of input data (e.g., data from database 402). In some instances, the dataset is generated by a data to instructions generator (e.g., 406), and the set of instructions are generated by an instructions controller (e.g., 408).

At 1006, the process can include generating a set of instructions from the dataset. In some instances, the instructions controller (e.g., 408) controls a number of instructions in the set of instructions. In some instances, the instructions controller interacts with a large language model (LLM) (e.g., 410) to generate the set of instructions.

At 1008, the process can include generating, for each of the set of instructions, a code set (e.g., at 418) and a test code set (e.g., 420) for testing the code set according to each instruction of the set of instructions. In a first example, the dataset includes any of a set of integers, real values, categorical data, and float values, and the set of instructions include instructions to generate functions to perform an action relating to any portion of the dataset. In another example, the dataset includes sample text, the set of instructions include instructions to generate a function to perform an action relating to a portion of the sample text, and the code set includes the function providing instructions to perform the action relating to the portion of the sample text.

At 1010, the process can include merging the code set and the test code set into a merged code set (e.g., at 422). At 1012, the process can include validating the merged code set (e.g., at 424). In some instances, validating the merged code set further comprises obtaining, for the merged code set, a set of feedback (e.g., at 426) and generating a reward based on the set of feedback. A subsequent code set and test code set can be generated based on the generated reward being negative.

At 1014, the process can include re-training the machine learning model using the merged code set (e.g., at 430). At 1016, the process can include deploying the re-trained machine learning model (e.g., at 432).

### Computing System Overview

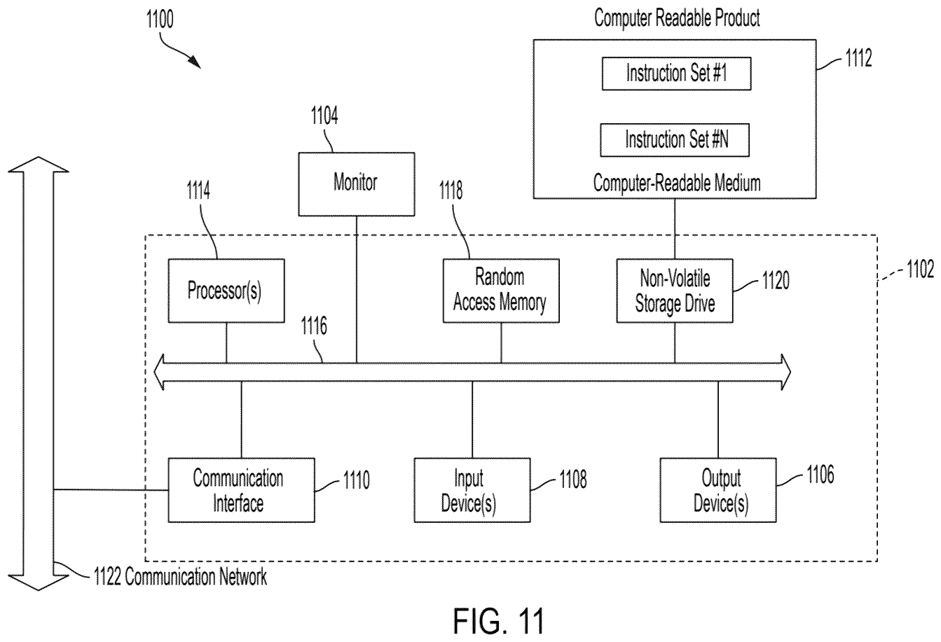

FIG. 11 is a block diagram of a special-purpose computer system 1100 according to an embodiment. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 1100 comprises a computer 1102, a monitor 1104 coupled to computer 1102, one or more additional user output devices 1106 (optional) coupled to computer 1102, one or more user input devices 1108 (e.g., keyboard, mouse, track ball, touch screen) coupled to computer 1102, an optional communications interface 1110 coupled to computer 1102, and a computer-program product including a tangible computer-readable storage medium 1112 in or accessible to computer 1102. Instructions stored on computer-readable storage medium 1112 may direct system 1100 to perform the methods and processes described herein. Computer 1102 may include one or more processors 1114 that communicate with a number of peripheral devices via a bus subsystem 1116. These peripheral devices may include user output device(s) 1106, user input device(s) 1108, communications interface 1110, and a storage subsystem, such as random-access memory (RAM) 1118 and non-volatile storage drive 1120 (e.g., disk drive, optical drive, solid state drive), which are forms of tangible computer-readable memory.

Computer-readable medium 1112 may be loaded into random access memory 1118, stored in non-volatile storage drive 1120, or otherwise accessible to one or more components of computer 1102. Each processor 1114 may comprise a microprocessor, such as a microprocessor from Intel® or Advanced Micro Devices, Inc.®, or the like. To support computer-readable medium 1112, the computer 1102 runs an operating system that handles the communications between computer-readable medium 1112 and the above-noted components, as well as the communications between the above-noted components in support of the computer-readable medium 1112. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 1108 include all possible types of devices and mechanisms to input information to computer system 1102. These may include a keyboard, a keypad, a mouse, a scanner, a digital drawing pad, a touch screen incorporated into the display, audio input devices such as voice recognition systems, microphones, and other types of input devices. In various embodiments, user input devices 1108 are typically embodied as a computer mouse, a trackball, a track pad, a joystick, wireless remote, a drawing tablet, a voice command system. User input devices 1108 typically allow a user to select objects, icons, text and the like that appear on the monitor 1104 via a command such as a click of a button or the like. User output devices 1106 include all possible types of devices and mechanisms to output information from computer 1102. These may include a display (e.g., monitor 1104), printers, non-visual displays such as audio output devices, etc.

Communications interface 1110 provides an interface to other communication networks and devices and may serve as an interface to receive data from and transmit data to other systems, WANs and/or the Internet, via a wired or wireless communication network 1122. In addition, communications interface 1110 can include an underwater radio for transmitting and receiving data in an underwater network. Embodiments of communications interface 1110 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1110 may be coupled to a computer network, to a FireWire® bus, or the like. In other embodiments, communications interface 1110 may be physically integrated on the motherboard of computer 1102, and/or may be a software program, or the like.

RAM 1118 and non-volatile storage drive 1120 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1118 and non-volatile storage drive 1120 may be configured to store the basic programming and data constructs that provide the functionality of various embodiments of the present invention, as described above.

Software instruction sets that provide the functionality of the present invention may be stored in computer-readable medium 1112, RAM 1118, and/or non-volatile storage drive 1120. These instruction sets or code may be executed by the processor(s) 1114. Computer-readable medium 1112, RAM 1118, and/or non-volatile storage drive 1120 may also provide a repository to store data and data structures used in accordance with the present invention. RAM 1118 and non-volatile storage drive 1120 may include a number of memories including a main random-access memory (RAM) to store instructions and data during program execution and a read-only memory (ROM) in which fixed instructions are stored. RAM 1118 and non-volatile storage drive 1120 may include a file storage subsystem providing persistent (non-volatile) storage of program and/or data files. RAM 1118 and non-volatile storage drive 1120 may also include removable storage systems, such as removable flash memory.

Bus subsystem 1116 provides a mechanism to allow the various components and subsystems of computer 1102 communicate with each other as intended. Although bus subsystem 1116 is shown schematically as a single bus, alternative embodiments of the bus subsystem may utilize multiple busses or communication paths within the computer 1102.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

### CONCLUSION

Whereas many alterations and modifications of the present invention will no doubt become apparent to a person of ordinary skill in the art after having read the foregoing description, it is to be understood that the particular embodiments shown and described by way of illustration are in no way intended to be considered limiting.

Moreover, the processes described above, as well as any other aspects of the disclosure, may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and optical data storage devices. In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system, device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for retraining a machine learning model in response to detecting a concept drift of the machine learning model, the method comprising:
obtaining a detection of an occurrence of a concept drift in a machine learning model;
generating a dataset specific to the machine learning model from a set of input data;
generating a set of instructions from the dataset;
generating, for each of the set of instructions, a code set and a test code set for testing the code set according to each instruction of the set of instructions;
merging the code set and the test code set into a merged code set;
validating the merged code set;
re-training the machine learning model using the merged code set; and
deploying the re-trained machine learning model.

2. The method of claim 1, wherein detecting the occurrence of concept drift comprises:
periodically evaluating an output accuracy of the machine learning model; and
determining that the output accuracy of the machine learning model is below a threshold level.

3. The method of claim 1, wherein the dataset is generated by a data to instructions generator, and wherein the set of instructions are generated by an instructions controller.

4. The method of claim 3, further comprising:
controlling, by the instructions controller, a number of instructions in the set of instructions generated by the instructions controller.

5. The method of claim 3, further comprising:
interacting, by the instructions controller, with a large language model (LLM) to generate the set of instructions.

6. The method of claim 1, wherein validating the merged code set further comprises:
obtaining, for the merged code set, a set of feedback; and
generating a reward based on the set of feedback, wherein a subsequent code set and test code set are generated based on the generated reward being negative.

7. The method of claim 1, wherein the dataset comprises any of a set of integers, real values, categorical data, and float values, and wherein the set of instructions comprise instructions to generate functions to perform an action relating to any portion of the dataset.

8. The method of claim 1, wherein the dataset comprises sample text, the set of instructions comprise instructions to generate a function to perform an action relating to a portion of the sample text, and the code set comprises the function providing instructions to perform the action relating to the portion of the sample text.

9. A system comprising:
a processor; and
a computer readable medium containing instructions that, when executed by the processor, cause the processor to perform operations comprising:
obtaining a detection of an occurrence of a concept drift in a machine learning model;
generating a dataset specific to the machine learning model from a set of input data;
generating a set of instructions from the dataset;
generating, for each of the set of instructions, a code set and a test code set for testing the code set according to each instruction of the set of instructions;
re-training the machine learning model using the code set and the test code set; and
deploying the re-trained machine learning model.

10. The system of claim 9, wherein the instructions further cause the processor to perform operations comprising:
merging the code set and the test code set into a merged code set, wherein the machine learning model is trained using the merged code set; and
validating the merged code set.

11. The system of claim 10, wherein validating the merged code set further comprises:
obtaining, for the merged code set, a set of feedback; and
generating a reward based on the set of feedback, wherein a subsequent code set and test code set are generated based on the generated reward being negative.

12. The system of claim 9, wherein detecting the occurrence of the concept drift comprises:
periodically evaluating an output accuracy of the machine learning model; and
determining that the output accuracy of the machine learning model is below a threshold level.

13. The system of claim 9, wherein the dataset is generated by a data to instructions model, and wherein the set of instructions are generated by an instructions controller.

14. The system of claim 13, wherein the instructions controller controls a number of instructions in the set of instructions.

15. The system of claim 13, wherein the instructions controller interacts with a large language model (LLM) to generate the set of instructions.

16. A computer-readable storage medium containing program instructions for a method being executed by an application, the application comprising code for one or more components that are called by the application during runtime, wherein execution of the program instructions by one or more processors of a computer system causes the one or more processors to perform steps comprising:
obtaining a detection of an occurrence of a concept drift in a machine learning model;
generating, by a data to instructions generator, a dataset specific to the machine learning model from a set of input data;
generating, by an instructions controller, a set of instructions from the dataset, wherein a number of instructions in the set of instructions are controlled by the instructions controller;
generating, for each of the set of instructions by an operations code generator, a code set according to each instruction of the set of instructions;
generating, for each of the set of instructions by a test operations code generator, a test code set for testing the code set;
merging the code set and the test code set into a merged code set;
validating the merged code set; and
training the machine learning model using the code set and the test code set; and
deploying the trained machine learning model.

17. The computer-readable storage medium of claim 16, wherein detecting the occurrence of concept drift comprises:
periodically evaluating an output accuracy of the machine learning model; and
determining that the output accuracy of the machine learning model is below a threshold level.

18. The computer-readable storage medium of claim 16, wherein the instructions controller interacts with a large language model (LLM) to generate the set of instructions.

19. The computer-readable storage medium of claim 16, wherein validating the merged code set further comprises:
obtaining, for the merged code set, a set of feedback; and
generating a reward based on the set of feedback, wherein a subsequent code set and test code set are generated based on the generated reward being negative.

20. The computer-readable storage medium of claim 16, wherein the dataset comprises any of a set of integers, real values, categorical data, and float values, and wherein the set of instructions comprise instructions to generate functions to perform an action relating to any portion of the dataset.
